(19) United States
(12) Patent Application Publication
(10) Pub. No.: US 2012/0307970 A1
(43) Pub. Date: Dec. 6, 2012

(54) MULTISPOT X-RAY PHASE-CONTRAST IMAGING SYSTEM

(75) Inventors: Timothy John Sommerer, Niskayuna, NY (US); Peter Michael Edic, Albany, NY (US); Dirk Wim Jos Bequé, Munchen (DE); Cristina Francesca Cozzini, Munchen (DE)

(73) Assignee: GENERAL ELECTRIC COMPANY, Schenectady, NY (US)

(21) Appl. No.: 13/149,577

(22) Filed: May 31, 2011

(51) Int. Cl. G01N 23/04

(52) U.S. Cl. 378/62

(57) ABSTRACT

A phase-contrast imaging system and method. An embodiment of the invention includes a plurality of X-ray emitters for transmitting X-rays through an object to a detector. Adjacent X-ray emitters may be activated at different times to prevent confounding of X-ray striking on the detector. Each X-ray emitter can be operated independently to provide different flux outputs for reducing overall patient dose.

### FIELD

The invention relates to an X-ray radiographic imaging system and method, and more particularly, to an X-ray radiographic imaging system and method capable of imaging soft tissue.

### BACKGROUND

X-ray radiography is an imaging technique whereby X-ray radiation is applied to a patient or an object to produce images of its internal structures (on film or digital media). Conventional x-ray radiography has limited utility in discriminating between soft tissues with similar attenuation coefficients, thus making it less suited for imaging of this type of tissue. Specifically, this effect occurs because of the subtle differences in energy-dependent mass attenuation coefficients for various soft tissue types. These differences decrease at higher X-ray energies, thereby making it difficult to measure these differences accurately.

Mathematical modeling of the interaction of X-rays with matter utilizes a construct known as the complex index of refraction, which comprises a real component modeling refractive characteristics of X-ray radiation and an imaginary component modeling absorptive characteristics of X-ray radiation. Depending upon the material type, thickness, and the spectrum of the applied X-ray radiation, the refractive component of the complex index of refraction may provide more and better information for identifying subtle differences in tissues properties at X-ray energies than conventional absorption imaging methods. Conventional radiography is sensitive to large differences in absorptive properties of X-rays, such as those between bones and tissue. For example, an X-ray image of a head will clearly reveal the bones of the skull, since they absorb much radiation. The image will not, however, reveal much of the internal brain structure, which will be presented as a relatively featureless region on the X-ray image. Unlike conventional radiography, which is based on the absorption of X-rays, phase-sensitive imaging has the potential to distinguish various types of soft tissue such as muscles and tendons, all in high contrast.

With higher soft tissue contrast found in phase-sensitive imaging, imaged features within the scanned volume may be more clearly distinguished, including any tissue abnormalities such as the presence of tumorous tissue. Thus, phase-sensitive imaging has the potential to reveal the size and position of, for example, a tumor at an early stage, enabling doctors to determine the right treatment, including one or more of drug therapy, needle biopsy, and the appropriate dosage of radiation therapy.

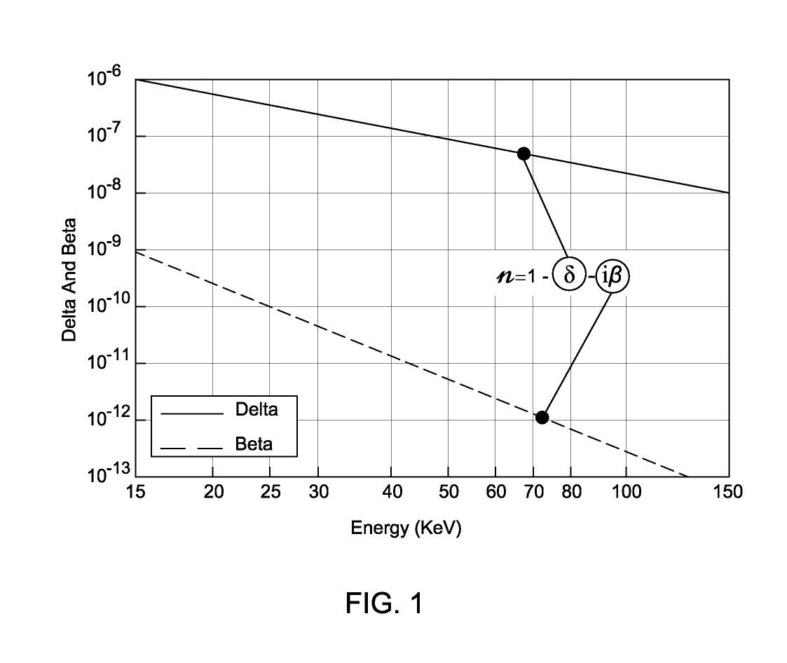

Since the real component (refractive component) of the complex index of refraction of materials is close to unity, it is typically characterized by 1−δ, where δ is the difference from unity. For nearly all elements in the periodic table, delta (δ) is larger than the imaginary part beta (β), where the complex index of refraction n is defined as n=1−δ−iβ. Data for breast tissue is shown in FIG. 1. Lewis et al., “Medical phase contrast x-ray imaging: current status and future prospects,” Phys. Med. Biol, Vol. 49, pp. 3573-3583, 2004. Here, δ is 10³ to 10⁵ times larger than the imaginary part β for X-ray photon energies over the range 20-150 keV that are typically used for diagnostic medical imaging. Although it is tempting to postulate that a large ratio of delta to beta will result in significant contrast boost in an image, one has to realize that beta is a signal absorptive term. Hence, the tissue contrast provided in an image depends on the tissue type that is imaged, the thickness of the tissue, and the spectrum of the applied X-ray radiation. The large difference between δ and β is true for most materials, including, for example, breast tissue, across a range of energy spectra from 20 keV to 150 keV. Thus, phase-sensitive imaging methods may be more sensitive to soft tissues than attenuation-based imaging methods. Since phase-sensitive imaging methods detect complementary information relative to standard attenuation imaging methods, and may provide higher soft tissue contrast, phase-sensitive imaging may provide the opportunity to expose persons to lower X-ray dosage.

It is possible to simultaneously measure both absorption and phase shifts of X-rays due to attenuation and refraction, respectively. Like visible light and all electromagnetic radiation, X-rays can be regarded as both particles and waves. Conventional absorption-based radiography records the extent to which X-rays penetrate anatomy or not. Phase-sensitive imaging measures the extent to which the X-ray wavefront is modified with respect to its original position via passing through an object, due to refractive properties of the object. This phase shift is very revealing because it varies depending on the nature of the tissue through which the radiation is refracted. However, conventional X-ray imaging methods are very insensitive to the phase-shift of X-rays; therefore, different detection methods are required.

Phase-contrast imaging (PCI) is a process for producing images on film or digital media using X-ray radiation, thereby visualizing the refractive properties of the imaged object or tissue. Several phase-sensitive imaging methods have been developed and are known to those skilled in the art, such as the propagation-based method, the interference method, the diffraction enhanced imaging method, and the X-ray differential phase-contrast imaging method. Such PCI processes are thus useful in medical diagnostic imaging techniques, such as, for example, mammography.

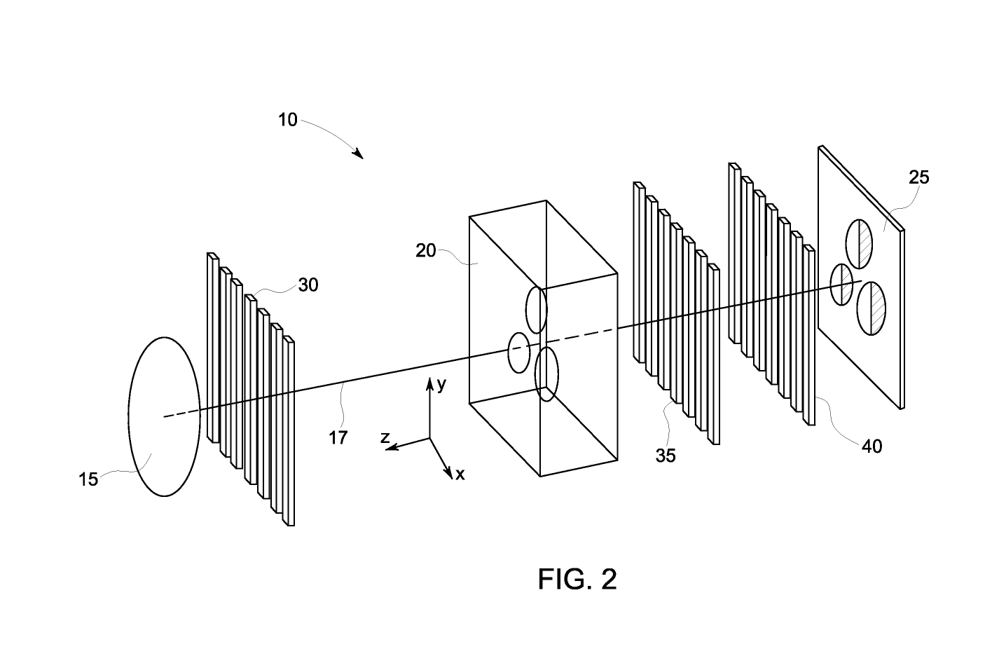

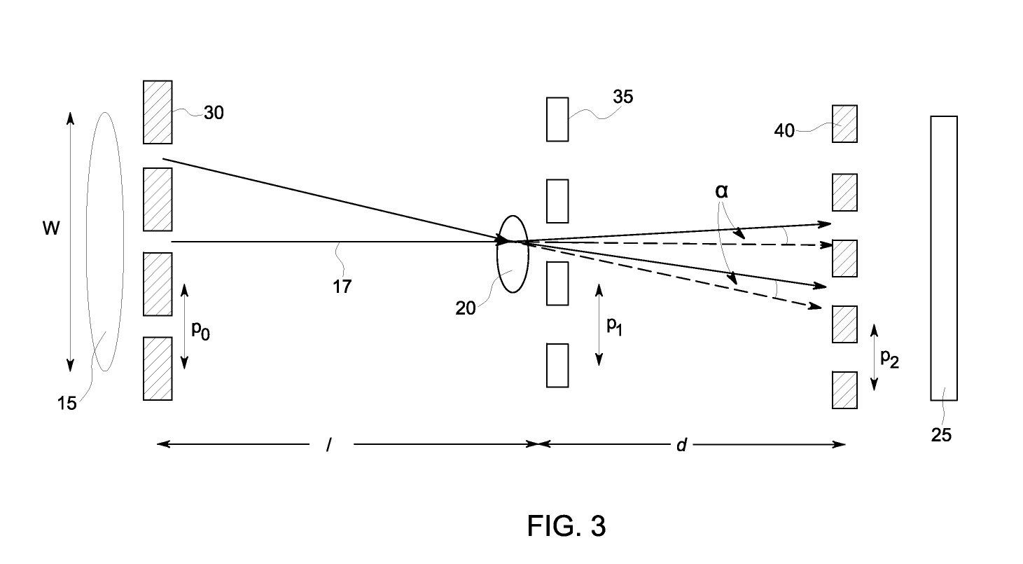

FIGS. 2 and 3 schematically illustrate a known PCI system 10. The PCI system 10 includes a potentially incoherent X-ray source 15, having a width w, which transmits X-ray radiation 17 through an object 20. The X-ray radiation 17 propagates through the object 20 and onto an imaging detector 25. For film-based PCI systems, the imaging detector 25 is in communication with a processor which processes the film. For digital PCI systems, the imaging detector 25 is in communication with a processor which processes the data obtained by the imaging detector 25 to formulate images of regions of interest of the object 20.

The X-rays from the X-ray source are partially transmitted through an absorbing grating 30, which may be formed by an alternating pattern of low- and high-attenuation materials (denoted as lines or rulings) such as silicon and gold, respectively. The thickness of each high-attenuation, individual line, or ruling, is sufficient to absorb the incident X-rays. The use of absorbing grating 30 provides a mechanism to generate pseudo-coherent wavefronts of electromagnetic radiation, thereby allowing the use of a standard X-ray source instead of a synchrotron.

Absorbing grating 30 creates an array of individually coherent but mutually incoherent secondary X-ray sources. If the width w of the primary X-ray source 15 is sufficiently small, such that the X-ray source 15 is coherent itself, the absorbing grating 30 may be removed from the system 10. Impingement of the X-rays 17 on the object 20 creates a slight refraction α of each of the coherent subsets of X-rays 17. The refraction amount is proportional to the local differential phase gradient of the object 20. A small angular deviation of the transmitted X-rays resulting from the refraction a results in a change of the locally transmitted intensity through the combination of gratings 35 and 40. Grating 35 is a non-absorbing phase grating, formed of individual lines or rulings comprising silicon or nickel or other material having low attenuating properties while creating large phase shifts. Alternatively, grating 35 is an absorption grating. Although shown as being positioned between the object and grating 40, grating 35 may be positioned between grating 30 and object 20. Grating 40 is an absorbing grating, formed of individual grates comprising an alternating pattern of low- and high-attenuation materials, such as silicon and gold. This grating allows improved sampling of the phase-contrast signal utilizing detectors with relatively coarse resolution by repeated stepping of the grate and measurement of the detector signal. For detectors capable of completely resolving the phase-contrast signal, the grating 40 can be removed from the system 10 and the stepping procedure is then not required in the measurement procedure.

The distance from the grating 30 to the grating 35 is l, and the distance from the grating 35 to the grading 40 is d. The measurement from the midpoint of one high-attenuation line or ruling of absorbing grating 30 to the midpoint of an adjacent high-attenuation line or ruling is the grating pitch p₀. The grating pitch of non-absorbing grate 35 is p₁; the grating pitch of absorbing grate 40 is p₂.

To obtain high quality images of the object 20 at the detector 25, it is necessary for each of the coherent subsets of X-rays 17 to contribute constructively to the image-formation process at the detector 25. For that to occur, a geometry of the system 10 should satisfy the equation:

p₀=p₂×l/d.

One disadvantage of the PCI system 10 is its size. Since practical gratings and detectors are planar in shape, the preferred X-ray beam is a plane-wave. The plane-wave is approximated by locating a conventional X-ray tube 15 at a relatively large distance from the object; a typical source-to-detector distance may be between about 150 and about 200 centimeters (cm). Such a distance is considerably longer than the source-to-object distance of approximately 65 cm, which is typical of the distance found in traditional mammography systems. Another disadvantage of the PCI system 10, for practical use in diagnostic medical imaging, is the limited field-of-view (FOV). The FOV of the PCI system 10 is about five to six centimeters wide and about two centimeters in height.

It is desired to implement an improved phase-contrast imaging system and method. Such an improved PCI system would desirably reduce the overall size of the system as well as increase the imaging field of view of known PCI systems.

### SUMMARY

An embodiment of the invention provides a phase-contrast imaging system having a plurality of X-ray emitters.

One aspect of the invention provides a phase-contrast imaging system that includes a detector and a non-absorbing grating positioned between the object to be imaged and the detector or between the plurality of X-ray emitters and the object to be imaged.

An embodiment of the invention provides a method for phase-contrast imaging an object that includes transmitting X-rays from a plurality of X-ray emitters through an object to a detector.

One aspect of the invention provides a method for phase-contrast imaging that includes optionally transmitting the X-rays through the first absorbing grating into the object, propagating the X-rays through the object, and transmitting the X-rays through a central non-absorbing or absorbing grating, and optionally through a second absorbing grating to the detector.

These and other features, aspects and advantages of the present invention may be further understood and/or illustrated when the following detailed description is considered along with the attached drawings.

DESCRIPTION OF THE DRAWINGS

FIG. 1 is a graph plotting a parameter of the real part and the imaginary part of the complex index of refraction against energy. Lewis et al., “Medical phase contrast x-ray imaging: current status and future prospects,” Phys. Med. Biol, Vol. 49, pp. 3573-3583, 2004.

FIG. 2 is a schematic view of a known phase-contrast imaging system. Pfeiffer et al., “Phase retrieval and differential phase contrast imaging with low-brilliance X-ray sources,” Nature Physics, Vol. 2, pp. 258-261, 2006.

FIG. 3 is a schematic top view of the phase-contrast imaging system of FIG. 2. Pfeiffer et al., “Phase retrieval and differential phase contrast imaging with low-brilliance X-ray sources,” Nature Physics, Vol. 2, pp. 258-261, 2006.

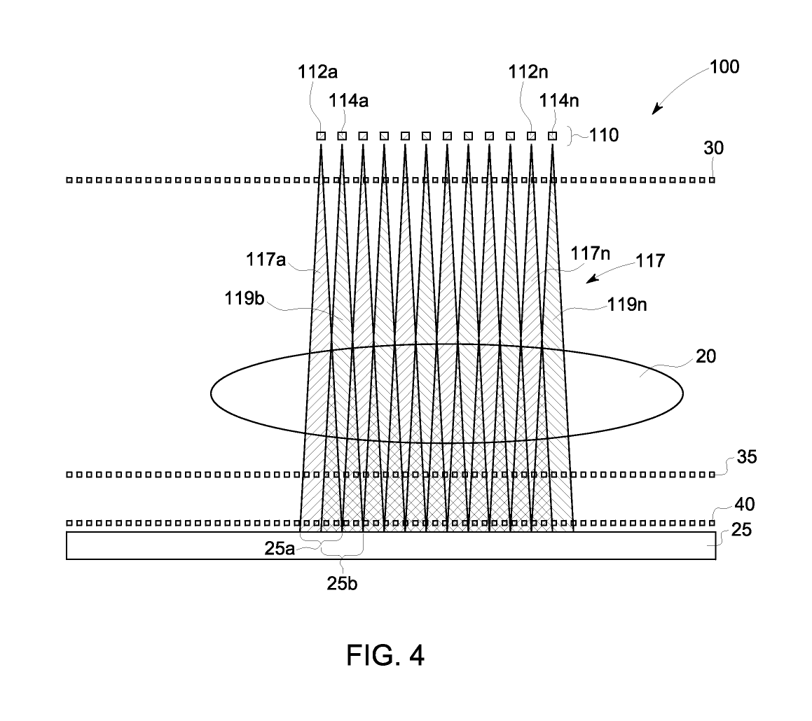

FIG. 4 is a schematic top view of a phase-contrast imaging system in accordance with an embodiment of the invention.

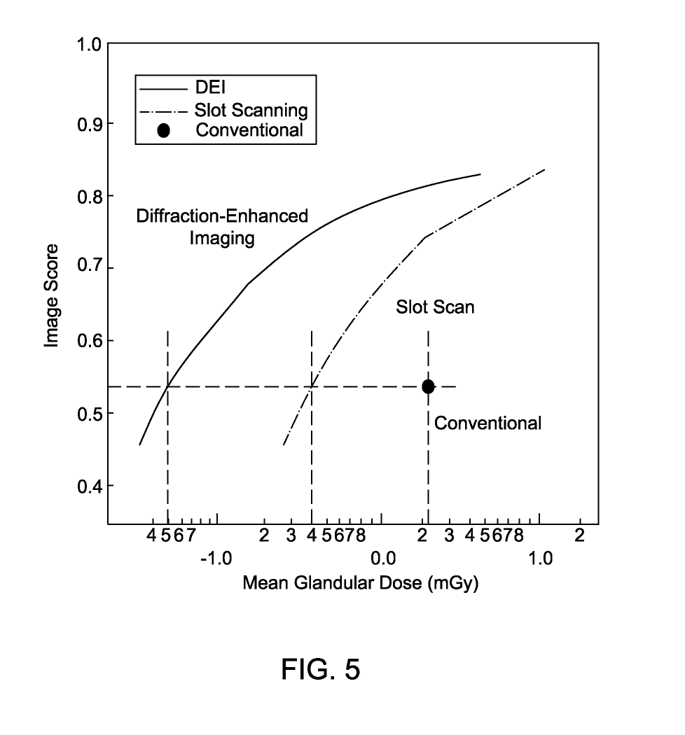

FIG. 5 is a graph plotting image score against mean glandular dose.

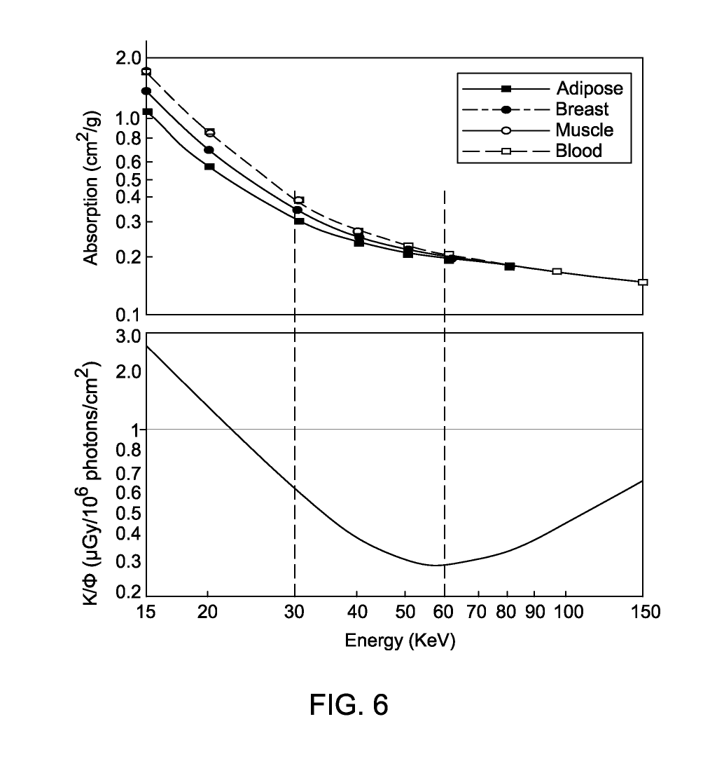

FIG. 6 is a graph plotting absorption and exposure of radiation energy against operating energy.

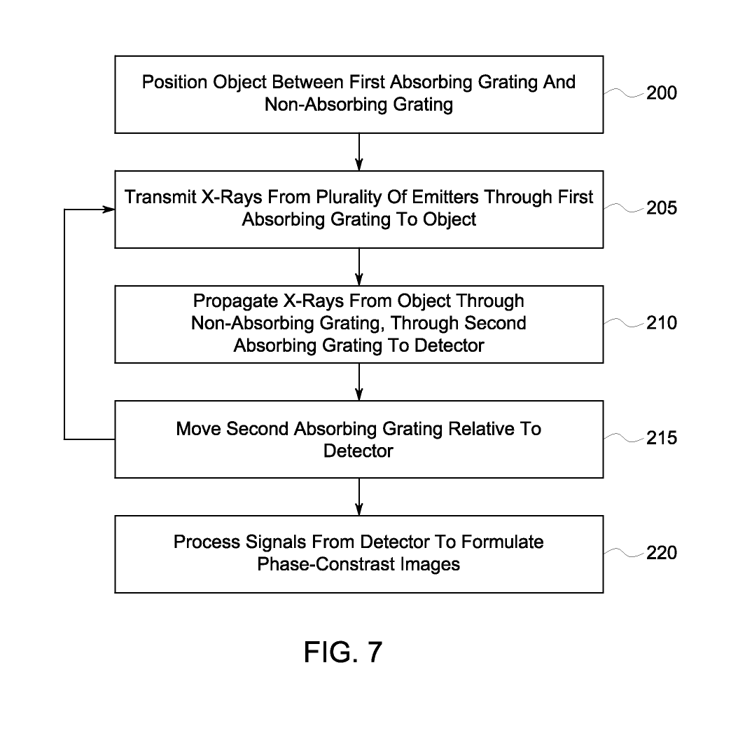

FIG. 7 illustrates a process for phase-contrast imaging an object in accordance with an embodiment of the invention.

### DETAILED DESCRIPTION

The present specification provides certain definitions and methods to better define the embodiments and aspects of the invention and to guide those of ordinary skill in the art in the practice of its fabrication. Provision, or lack of the provision, of a definition for a particular term or phrase is not meant to imply any particular importance, or lack thereof; rather, and unless otherwise noted, terms are to be understood according to conventional usage by those of ordinary skill in the relevant art.

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.).

The modifier “about” used in connection with a quantity is inclusive of the stated value and has the meaning dictated by the context (e.g., includes the degree of error associated with measurement of the particular quantity). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

A phase-contrast imaging (PCI) system 100 illustrated in FIG. 4 includes an X-ray source which transmits X-rays, potentially through an absorbing grating 30 to an object 20. After propagating through the object 20, the X-rays extend through non-absorbing or absorbing central grating 35 and potentially through absorbing grating 40 to X-ray detector 25. Alternatively, the non-absorbing grating 35 may be located between the X-ray source and the object 20.

The X-ray source of PCI system 100 includes an array 110 of X-ray focal spots or emitters. The X-ray spots can be of any type of X-ray emitting device, including but not limited to X-rays generated from electron beams provided by tungsten filaments, cold-cathode emission devices, field emitters, and carbon nanotubes, comprising both reflection or transmission sources. In one embodiment of a PCI system 100 for use in mammography operations, the individual emitters in the array 110 may have a width of about 0.3 millimeters. In one embodiment, the pitch between emitters is approximately 1.3 centimeters. For a linear array of 12 emitters having an individual emitter size of 0.3 centimeters and a distance of 1.3 centimeters between spots provides a field-of-view of approximately 20 cm at the array 110.

In one embodiment, the array 110 has a first set of X-ray focal spots 112 interleaved with a second set of X-ray focal spots 114. Each set 112 includes 112a to 112n number of X-ray focal spots. The X-ray focal spots 112a through 112n emit, respectively, X-rays 117a through 117n. Each set 114 includes 114a to 114n number of X-ray focal spots. The X-ray focal spots 114a through 114n emit, respectively, X-rays 119a through 119n. It should be understood that the X-ray flux of each individual focal spot can be varied individually, i.e. different spots of the same set of focal spots can be operated to provide different X-ray intensities on portions of object 20. This allows adaptation of the emitted radiation to the patient, thereby achieving optimal image quality at the lowest possible patient dose. Moreover, individual X-ray focal spots 112a to 112n, or 114a to 114n, may be operated simultaneously, or they may be operated sequentially. Both sets of X-ray focal spots are identified in FIG. 4. This is only one possible embodiment; two or more subsets of X-ray focal spots may be identified.

Although the array 110 is shown to be in one dimension, it should be understood that the array may be arranged in two dimensions. In one embodiment, the array 110 comprises a linear array of approximately 10 emitters. In another embodiment, the array 110 comprises a two dimensional array of approximately 16 emitters. It should be understood that the number of emitters can be two or more. It should be further understood that a two dimensional array may have three or more emitters, and may be formed in a 2×2, 3×3, 4×4, etc. square array or an interleaved 1×2 triangular array or an interleaved 2×3, 2×4, etc. rectangular array. In addition, the array 110 may be formed in a non-planar fashion, for example, curved in one direction.

Furthermore, each emitter may include a microfocus or an array of individual sub-sources. Each of the sub-sources is individually coherent but mutually incoherent to the other sub-sources. The array of sub-sources may be generated by placing an array of slits, i.e. an additional amplitude grating close to the source or creating an array of sub-microfoci (for examples with carbon nanotubes).

For a PCI system 100 to be used in mammography, the high-attenuation lines or grates of grating 30 are made of a certain material and thickness to block approximately all of the X-rays incident on the lines accounting for a total blockage of 50 percent or more of X-rays incident on the grating 30.

As shown in FIG. 4, there is an overlap of emitted X-rays 117, 119 between adjacent X-ray focal spots 112, 114. For example, X-rays 117a overlap with X-rays 119a and X-rays 117n overlap with X-rays 119n. The sequenced operation of X-ray focal spots 112 and 114 will be described below.

The utilization of numerous X-ray focal spots overcomes the deficiency in conventional PCI systems of a limited FOV. In forming a phase-contrast image, each X-ray focal spot can be considered independently. Further, data can be acquired at the detector 25 when several X-ray focal spots are emitting.

Additionally, the PCI system 100 overcomes the deficiency of conventional PCI systems, such as PCI system 10, in that the distance from the emitters 110 to the detector 25 can be reduced from the 100 to 200 centimeters found in PCI system 10 to the distance found in conventional mammography systems. Lateral dimensions, such as focal spot width w and the grating pitches pᵢ are also scaled in proportion.

Abutment or overlapping of adjacent X-ray emissions is necessary to ensure complete coverage of the object being imaged. To alleviate any potential confusion regarding the data signals at the detector from multiple X-ray emissions, however, one embodiment has adjacent X-ray focal spots operating at separate times. For example, X-ray focal spots 112 emit at a first time and X-ray focal spots 114 emit at a second time different than the first time. Specifically, X-ray focal spots 112, including 112a, are operated and emit X-rays 117, including X-rays 117a. X-rays 117a impinge, after transmission through the grating 30, object 20, and gratings 35 and 40, on section 25a of the detector 25. Data is acquired from section 25a of the detector by a processor (not shown). After the readout to the processor, X-ray focal spots 114, including X-ray focal spot 114a are operated. X-rays 119b impinge on section 25b of the detector 25. As illustrated, section 25b overlaps with section 25a of the detector 25. It should be understood that the emitters 110 and gratings 30, 35, 40 and detector 25 can be positioned relative to one another such that adjacent sections of the detector 25, like sections 25a and 25b, abut one another instead of overlap one another.

After a full cycle of operation of all the X-ray focal spots, the grating 40 may be moved relative to the detector 25 and another full cycle of operation of the X-ray focal spots is performed. The movement of the grating 40 is a small distance, based upon the equation p₂/n, where n equals the desired oversampling of the phase-contrast signal. It is important for the detector 25 to be able to detect the phase modulation, and one option for that is utilizing the absorbing grating with stepping. As mentioned previously, if a detector with suitable resolution to sample the phase-contrast signal is available, grating 40 can be eliminated and only one data collection is needed for each set of X-ray focal spots.

Referring now to FIG. 5, conventional mammography operates at a low X-ray photon energy value, typically 10-40 keV, where the absorption contrast between different soft tissues is larger. At this lower energy level, the absorption contrast is higher. Since PCI systems, such as PCI system 100, do not operate on an X-ray absorption basis but instead operate on an X-ray phase-contrast basis, PCI systems can operate at higher energy levels, such as 60 keV. At such a level, the absorbed dose is lower leading to less exposure to harmful ionizing radiation for a patient. Further, as indicated in FIG. 5, experience with diffraction-enhanced imaging, which is a particular type of phase-contrast imaging indicates that radiologists are able to detect features in images from phase-contrast imaging at a much lower X-ray dose, in comparison with conventional absorption x-ray images. The top plot in FIG. 6 show the energy-dependent absorption of various tissue types: adipose tissue, breast tissue, muscle and blood. The bottom plot in FIG. 6 shows the incremental dose per flux density as a function of photon energy. For the bottom plot, one can see the incremental dose per flux density is minimized at an approximate X-ray energy of 60 keV.

Referring now to FIG. 7, a method is described for imaging an object, such as a patient, with a PCI imaging system, such as PCI system 100. At Step 200, the object is positioned at a location between a plurality of X-ray emitters and a central non-absorbing or absorbing grating. When present in the system, the first absorbing grating is positioned relative to a plurality of X-ray emitters and the high-attenuation lines or grates are manufactured so as to block more than 50 percent of the emitted X-rays. Ideally, all X-rays that impinge upon the high-attenuation (absorbing) part of the grating are attenuated, and all X-rays impinging on the low-attenuation lines or grates are transmitted.

At Step 205, the plurality of X-ray emitters transmit X-rays into the object, potentially through a first absorbing grating, which absorbs some of the X-rays allowing the remainder to be transmitted into the object. Step 205 may be performed numerous times. For example, the plurality of X-ray emitters may be divided up into a first set of emitters interleaved with a second set of emitters. The first set of emitters may fire at a first time and the second set of emitters may fire at a second time different than the first time.

At Step 210, the X-rays propagate through the object and continue through the non-absorbing or absorbing grating, and potentially through a second absorbing grating, to a detector. The plurality of X-ray emitters are positioned relative to one another and relative to the gratings and the detector such that impingement of X-rays from adjacent emitters at least abuts one another at the detector. Specifically, the X-rays from one emitter will strike the detector at a first detector portion and the X-rays from an adjacent emitter will strike the detector at a second detector portion. The first and second detector portions will at least abut one another but may overlap one another. Since confusion at the detector over the origin of signals is to be avoided, adjacent emitters likely should fire at different time periods if the respective X-ray impingement areas will overlap at the detector. Like Step 205, Step 210 may be performed numerous times.

At Step 215, the second absorbing grating, when present in the system, may be moved relative to the detector and Steps 205 and 210 may be performed again. Alternatively, the central grating or the source grating, when present in the system, may instead be moved and then Steps 205 and 210 may be performed again. It should be appreciated that there are, in principle, several alternatives to this step which accomplish the same goal. Step 215 as described is not meant to be limiting, but comprises one mechanism for sampling the phase-contrast signal, as is known to those skilled in the art. The multiple imaging steps are performed to collect data formed at the detector that is used to construct the image that is presented to the radiologist. The above steps may further be repeated for different positions of the system with respect to the patient in order to perform tomosynthesis or tomography. For example, the process can be repeated at multiple angles of the source 15, multiple angles of the gratings 30, 35, 40, and multiple angles of the detector 25 relative to object 20 to reconstruct volumetric phase-contrast computed tomography images. As with Steps 205 and 210, Step 215 may be performed numerous times. Finally, at Step 220 the signals from the detector are forwarded to a processor to formulate the phase-contrast images of the object.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while embodiments have been described in terms that may initially connote singularity, it should be appreciated that multiple components may be utilized. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A phase-contrast imaging system comprising a plurality of X-ray emitters.

2. The phase-contrast imaging system of claim 1, wherein said plurality of X-ray emitters are arrayed in a linear fashion.

3. The phase-contrast imaging system of claim 1, wherein said plurality of X-ray emitters are arrayed in a two dimensional fashion.

4. The phase-contrast imaging system of claim 1, comprising:
a detector; and
a non-absorbing or absorbing grating positioned between the object to be imaged and the detector or between the plurality of X-ray emitters and the object to be imaged.

5. The phase-contrast imaging system of claim 4, wherein the plurality of X-ray emitters comprises at least two sets of emitters with at least a first set of emitters interleaved with a second set of emitters.

6. The phase-contrast imaging system of claim 5, wherein the first set of emitters transmit X-rays at a first time and the second set of emitters transmit X-rays at a second time different than the first time.

7. The phase-contrast imaging system of claim 5, wherein the X-ray intensity from the at least first set of emitters and the second set of emitters is variable and is adapted to minimize patient dose.

8. The phase-contrast imaging system of claim 5, wherein the plurality of X-ray emitters are positioned relative to the detector such that X-rays emitted from the first set of emitters impinge on a first detector portion and X-rays emitted from the second set of emitters impinge on a second detector portion, the first and second detector portions at least abutting one another.

9. The phase-contrast imaging system of claim 8, wherein the first and second detector portions overlap one another.

10. The phase-contrast imaging system of claim 4, further comprising an absorbing grating positioned between the plurality of X-ray emitters and the object.

11. The phase-contrast imaging system of claim 10, wherein the first absorbing grating is formed of gold and silicon lines.

12. The phase-contrast imaging system of claim 4, wherein the non-absorbing grating is formed of silicon or nickel.

13. The phase-contrast imaging system of claim 4, further comprising an absorbing grating positioned between the object and the detector.

14. The phase-contrast imaging system of claim 13, wherein the second absorbing grating is formed of gold and silicon lines.

15. The phase-contrast imaging system of claim 4, wherein the imaging system is a mammography system, a general radiography system, a tomosynthesis system, or a computed tomography system.

16. A method for phase-contrast imaging an object, comprising transmitting X-rays from a plurality of X-ray emitters through an object to a detector.

17. The method of claim 16, wherein said transmitting X-rays comprises:
optionally transmitting the X-rays through a first absorbing grating into the object;
propagating the X-rays through the object; and
transmitting the X-rays through a central non-absorbing or absorbing grating, and optionally through a second absorbing grating, to the detector.

18. The method of claim 17, further comprising moving the second absorbing grating relative to the detector after an intensity of X-rays striking the detector is measured.

19. The method of claim 16, further comprising processing signals from the detector to formulate phase-contrast images of the object.

20. The method of claim 16, wherein the plurality of X-ray emitters comprise at least two sets of emitters with a first set of emitters interleaved with a second set of emitters and wherein said transmitting comprises first transmitting from the first set of emitters at a first time and second transmitting from the second set of emitters at a second time different than the first time.

21. The method of claim 20, wherein said first transmitting strikes at a first detector position and said second transmitting strikes at a second detector position.

22. The method of claim 21, wherein said first and second detector positions abut one another.

23. The method of claim 21, wherein said first and second detector positions overlap one another.

24. The method of claim 16, wherein said transmitting comprises transmitting from the plurality of X-ray emitters arranged in a linear array.

25. The method of claim 16, wherein said transmitting comprises transmitting from the plurality of X-ray emitters arranged in a two dimensional array.
